(19) United States
(12) Patent Application Publication
(10) Pub. No.: US 2019/0215102 A1
(43) Pub. Date: Jul. 11, 2019

(54) TRANSMISSION TERMINAL, TRANSMISSION METHOD AND TRANSMISSION PROGRAM

(71) Applicant: NEC Corporation, Tokyo (JP)

(72) Inventor: Natsuki KAI, Tokyo (JP)

(73) Assignee: NEC CORPORATION, Tokyo (JP)

(21) Appl. No.: 16/328,887

(22) PCT Filed: Jul. 7, 2017
(86) PCT No.: PCT/JP2017/024964

§ 371 Date: Feb. 27, 2019

(30) Foreign Application Priority Data
Aug. 30, 2016 (JP) 2016-167948

(51) Int. Cl. H04L 1/00; H04L 1/20

(52) U.S. Cl. CPC H04L 1/0089; H04L 1/203

(57) ABSTRACT

A transmission terminal 20 is provided with: a storage unit 21 that stores transmission information including a packet loss rate in transmission processing executed in the past, the reliability of the packet loss rate, and performance data indicating the performance of the transmission processing on a transmission-processing-by-transmission-processing basis; a selection unit 22 that selects, from among the stored pieces of transmission information, transmission information having the maximum ratio of the reliability to a difference between data indicating the performance of measured transmission processing and the performance data; and a determination unit 23 that determines a redundancy to be attached to data to be transmitted in transmission processing the performance of which has been measured using the packet loss rate included in the selected transmission information.

### TECHNICAL FIELD

The present invention relates to a transmission terminal, a transmission method and a transmission program, and particularly relates to a transmission terminal, a transmission method and a transmission program that can change a redundancy attached to transmitted data according to variations in a state of a communication network used for data transmission.

### BACKGROUND ART

A packet loss frequently occurs in data transmission for which a communication network in a frequently varying state is used. As methods for addressing the frequent packet loss, an automatic repeat request (ARQ) and a forward error correction (FEC) are studied.

In the automatic repeat request, a packet is kept transmitted until an arrival acknowledgement (ACK) for the transmitted packet is returned. Alternatively, a packet is kept transmitted until a time out occurs. That is, in the automatic repeat request, arrival of transmitted data is guaranteed.

However, in the automatic repeat request, transmitted data for which a packet loss has occurred is transmitted again, and thus there occurs a delay by an amount of retransmission. That is, when the automatic repeat request is used as a method of data transmission, immediacy is impaired from data transmission.

Further, in the forward error correction, redundant data (for example, parity data) is attached to transmitted data. When the redundant data is attached, the reception side can decode the transmitted data even when a packet loss occurs. That is, when the forward error correction is used as a method of data transmission, the problem of packet loss can be solved without impairing immediacy from data transmission.

Examples of the forward error correction are described in PTL 1 to PTL 3. PTL 1 describes a method of performing redundant transmission so as to prevent increase of transmission delay while obtaining bandwidth efficiency when an input data rate and a transmittable band vary. The unit of input data rate and of transmittable band is, for example, bps.

PTL 2 describes a packet transmission device including a redundancy determination unit that dynamically determines an amount of redundancy on the basis of network state information received so as to prevent retransmission of undistributed packets after error correction in a receiver. Further, PTL 3 describes a video transmission system that determines a suitable packet amount for the amount of redundancy according to a state of a communication network.

Further, PTL 4 describes a network bandwidth measurement method that compares transmission intervals and reception intervals and computes an available band by using a measurement packet having a maximum packet size among measurement packets having transmission intervals and reception intervals that are equal.

### CITATION LIST

### Patent Literature

PTL 1: Japanese Patent Application Laid-Open No. 2014-225751

PTL 2: Japanese Translation of PCT International Application Publication No. 2016-502794

PTL 3: International Patent Application Publication No. 2011/065294

PTL 4: Japanese Patent No. 5928574

### SUMMARY OF INVENTION

### Technical Problem

The method described in PTL 1 executes redundancy coding without considering variations in packet loss rate, the variations accompanying a state change of a communication network. That is, there is demanded a method that executes redundancy coding considering variations in packet loss rate, the variations accompanying the state change of the communication network.

As described in PTL 2 and PTL 3, as a method considering variations in packet loss rate, a conceivable method is to estimate a future packet loss rate by using information of packet loss rates obtained in the past. However, in data transmission for which a best-effort communication network is used, in which quality of communication service is not guaranteed, there may occur a burst loss such that a large amount of packets are momentarily lost.

Information of packet loss rate obtained in the past with respect to data transmission for which a best-effort communication network is used includes information when a burst loss has occurred. That is, the estimation method of packet loss rate using information of packet loss rate obtained in the past can easily be affected by unusual value obtained when a burst loss occurs, and thus it is possible that an accurate packet loss rate cannot be estimated. As a method to solve the above-described problem, there is a method to simultaneously obtain a reliability of information of packet loss rate obtained in the past.

Further, a method described in PTL 4 is also conceivable, the method estimating a future packet loss rate by using a method to measure a throughput related to the communication network that affects the packet loss rate without using data obtained in the past. However, it is difficult to accurately measure and estimate a transmittable bandwidth that varies frequently. As a bandwidth difficult to accurately measure and estimate, for example, there is a UDP throughput, which is a throughput when data is transmitted by UDP (User Datagram Protocol).

Thus, redundancy coding when a bandwidth difficult to accurately measure and estimate is used is demanded to be executed with measurement errors of the bandwidth being considered in advance. When the redundancy coding is executed without considering measurement errors of the transmittable bandwidth, it is conceivable that useless data is transmitted or that decoding of data fails.

The measurement errors of the bandwidth are considered on the basis of, for example, data of the bandwidth measured in the past. The measurement errors are considered by using highly credible data measured in the past closest to a currently measured bandwidth.

Therefore, there is demanded a method to estimate a packet loss rate on the basis of data including a reliability measured in the past with the current state of the communication network being considered, and to execute the redundancy coding with the estimated packet loss rate.

### OBJECT OF INVENTION

Accordingly, it is an object of the present invention to provide a transmission terminal, a transmission method and a transmission program that solve the above-described problems and that are able to improve use efficiency of a transmittable band while addressing the packet loss with variations of the state of the communication network between a transmission terminal and a reception terminal being considered.

### Solution to Problem

A transmission terminal according to the present invention includes a storage unit which stores transmission information including a packet loss rate in transmission processing executed in past, a reliability of the packet loss rate, and performance data indicating performance of the transmission processing on a transmission-processing-by-transmission-processing basis, a selection unit which selects, from among the stored pieces of transmission information, transmission information having maximum ratio of the reliability to a difference between data indicating the performance of measured transmission processing and the performance data, and a determination unit which determines a redundancy to be attached to data to be transmitted in transmission processing the performance of which has been measured using the packet loss rate included in the selected transmission information.

A transmission method according to the present invention includes storing transmission information including a packet loss rate in transmission processing executed in past, a reliability of the packet loss rate, and performance data indicating performance of the transmission processing on a transmission-processing-by-transmission-processing basis, selecting, from among the stored pieces of transmission information, transmission information having maximum ratio of the reliability to a difference between data indicating the performance of measured transmission processing and the performance data, and determining a redundancy to be attached to data to be transmitted in transmission processing the performance of which has been measured using the packet loss rate included in the selected transmission information.

A transmission program causing a computer to execute storage processing of storing transmission information including a packet loss rate in transmission processing executed in past, a reliability of the packet loss rate, and performance data indicating performance of the transmission processing on a transmission-processing-by-transmission-processing basis, selection processing of selecting, from among the stored pieces of transmission information, transmission information having maximum ratio of the reliability to a difference between data indicating the performance of measured transmission processing and the performance data, and determination processing of determining a redundancy to be attached to data to be transmitted in transmission processing the performance of which has been measured using the packet loss rate included in the selected transmission information.

### Advantageous Effects of Invention

According to the present invention, use efficiency of a transmittable band can be improved while addressing the packet loss with variations of a state of the communication network between a transmission terminal and a reception terminal being considered.

### BRIEF DESCRIPTION OF DRAWINGS

FIG. 1 is a block diagram showing a configuration example of a first exemplary embodiment of a communication system 10 according to the present invention.

FIG. 2 is an explanatory diagram showing an example of a data set retained in a database unit 103.

FIG. 3 is a flowchart showing operations of estimation process of a packet loss rate performed by a loss rate estimation unit 106.

FIG. 4 is a flowchart showing operations of reliability update process performed by a reliability update unit 105.

FIG. 5 is a flowchart showing operations of redundancy determination process performed by a redundancy determination unit 107.

FIG. 6 is an explanatory diagram showing another example of a data set retained in the database unit 103.

FIG. 7 is an explanatory diagram showing another example of data sets retained in the database unit 103.

FIG. 8 is an explanatory diagram showing another example of data sets retained in the database unit 103.

FIG. 9 is an explanatory diagram showing another example of data sets retained in the database unit 103.

FIG. 10 is an explanatory diagram showing another example of data sets retained in the database unit 103.

FIG. 11 is an explanatory diagram showing another example of data sets retained in the database unit 103.

FIG. 12 is an explanatory diagram showing another example of data sets retained in the database unit 103.

FIG. 13 is an explanatory diagram showing another example of data sets retained in the database unit 103.

FIG. 14 is a block diagram showing an overview of a transmission terminal according to the present invention.

### DESCRIPTION OF EMBODIMENTS

### First Exemplary Embodiment

[Explanation of Configuration]

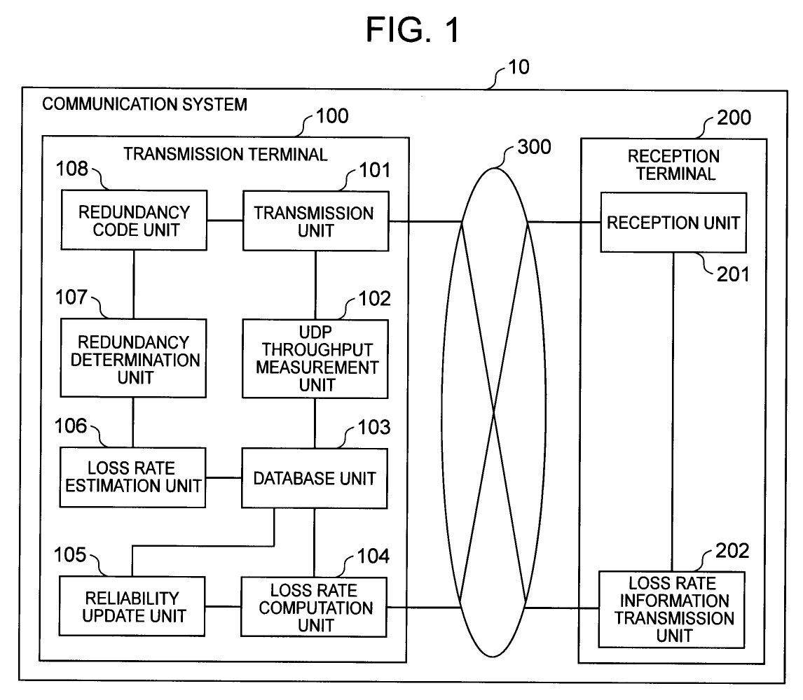

Hereinafter, an exemplary embodiment of the present invention will be explained with reference to drawings. FIG. 1 is a block diagram showing a configuration example of a first exemplary embodiment of a communication system 10 according to the present invention.

A communication system 10 of the present exemplary embodiment is a system that reduces packet losses in data transmission via a communication network by redundancy coding of data while changing the redundancy according to variations in a state of the communication network. The communication system 10 changes the redundancy according particularly to variations of a packet loss rate.

As showed in FIG. 1, the communication system 10 of the present exemplary embodiment includes a transmission terminal 100 and a reception terminal 200. Further, the transmission terminal 100 is communicatively connected to the reception terminal 200 via a communication network 300.

The transmission terminal 100 and the reception terminal 200 of the present exemplary embodiment are, for example, personal computers having a communication device. Note that the transmission terminal 100 and the reception terminal 200 may be terminal devices other than personal computers.

Further, the communication network 300 of the present exemplary embodiment may be constituted of heterogeneous networks. For example, the communication network 300 may be constituted of the Internet and a mobile network.

As showed in FIG. 1, the transmission terminal 100 includes a transmission unit 101, a UDP throughput measurement unit 102, a database unit 103, a loss rate computation unit 104, a reliability update unit 105, a loss rate estimation unit 106, a redundancy determination unit 107, and a redundancy code unit 108. The transmission terminal 100 assumes the role of a data transmission control device.

The transmission unit 101 has a function to transmit data by UDP. The transmission unit 101 transmits data to the reception terminal 200 via the communication network 300. Incidentally, the transmission unit 101 may transmit data by a communication protocol other than UDP.

The UDP throughput measurement unit 102 has a function to measure a UDP throughput which is the transmittable bandwidth described above. The UDP throughput measurement unit 102 measures the UDP throughput of the transmission unit 101. Incidentally, the UDP throughput measurement unit 102 may measure a transmittable bandwidth other than the UDP throughput.

The database unit 103 has a function to retain a data set containing various types of information related to executed data transmissions. The database unit 103 retains a data set of every data transmission executed.

The data set of the present exemplary embodiment includes a transmission data rate, a UDP throughput, a packet loss rate, and a reliability. Note that the unit of transmission data rate and the unit of UDP throughput are, for example, bit per second (bps).

The loss rate computation unit 104 has a function to compute a packet loss rate in an executed data transmission on the basis of information transmitted from the reception terminal 200. The loss rate computation unit 104 performs computation processing of the packet loss rate as will be described later.

The reliability update unit 105 has a function to update the reliability included in a data set retained in the database unit 103 on the basis of a value of the packet loss rate computed by the loss rate computation unit 104.

The reliability updated by the reliability update unit 105 on the basis of the value of the packet loss rate computed by the loss rate computation unit 104 is the reliability included in a data set used for estimation of the packet loss rate, which will be described later. The database unit 103 retains as data sets pieces of information each output from the UDP throughput measurement unit 102, the loss rate computation unit 104, and the reliability update unit 105. The reliability update unit 105 performs reliability update processing as will be described later.

The loss rate estimation unit 106 has a function to estimate the packet loss rate in a data transmission to be executed next on the basis of data sets related to data transmissions executed in the past, which are retained by the database unit 103. The loss rate estimation unit 106 performs estimation processing of packet loss rate as will be described later.

The redundancy determination unit 107 has a function to determine a redundancy of data to be transmitted next by using a value of the packet loss rate estimated by the loss rate estimation unit 106. The redundancy determination unit 107 performs redundancy determination processing as will be described later.

The redundancy code unit 108 has a function to make transmission data redundant by using a determination result of the redundancy determination unit 107. The redundancy code unit 108 performs redundancy coding of transmission data by using a redundancy determined by the redundancy determination unit 107.

Hereinafter, a data set registered in the database unit 103 when the transmission terminal 100 transmits i-th data will be described. Before i-th data is transmitted, the loss rate estimation unit 106 estimates a packet loss rate in transmission of i-th data. Hereinafter, a packet loss rate l′_i estimated by the loss rate estimation unit 106 will be referred to as an estimated packet loss rate.

Further, the UDP throughput measurement unit 102 measures UDP throughput u_i before i-th data is transmitted. Further, the transmission unit 101 obtains transmission data rate s_i before i-th data is transmitted. Incidentally, the transmission data rate s_i may be obtained by a component other than the transmission unit 101.

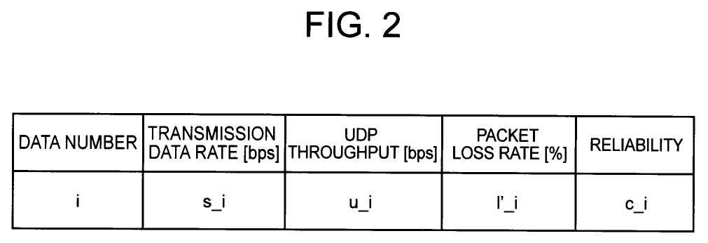

Just after i-th data is transmitted, a data set that is information at a time of transmitting i-th data is registered in the database unit 103 as showed in FIG. 2. FIG. 2 is an explanatory diagram showing an example of the data set retained in a database unit 103.

As showed in FIG. 2, the data set is constituted of a data number, a transmission data rate, a UDP throughput, a packet loss rate, and a reliability. The unit of transmission data rate and the unit of UDP throughput are bit per second (bps). Further, the unit of the packet loss rate is percent. The data number of the data set showed in FIG. 2 is “i” because the data set is information at a time of transmitting i-th data.

Further, because each piece of information obtained before i-th data is transmitted is registered as described above, the transmission data rate of the data set showed in FIG. 2 is “s_i”, the UDP throughput thereof is “u_i”, and the packet loss rate thereof is “1′_i”. Further, a reliability of the data set showed in FIG. 2 is “c_i”. Incidentally, an initial value of c_i, that is, the reliability when the data set is initially registered is “1.0”.

Note that a packet loss rate computed by the loss rate computation unit 104 after i-th data is transmitted, that is, an actually measured packet loss rate is l_i. Hereinafter, l_i refers to an actually measured packet loss rate. Further, a redundancy attached to i-th data by redundancy coding is r_i.

Further, as showed in FIG. 1, the reception terminal 200 includes a reception unit 201 and a loss rate information transmission unit 202.

The reception unit 201 has a function to receive data transmitted from the transmission unit 101 of the transmission terminal 100. When the transmission unit 101 transmits data by UDP, the reception unit 201 receives the data by UDP.

The loss rate information transmission unit 202 has a function to transmit information needed by the loss rate computation unit 104 of the transmission terminal 100 to compute a packet loss rate. The loss rate information transmission unit 202 transmits information to the transmission terminal 100 via the communication network 300.

For example, operations of the loss rate computation unit 104 performed when the transmission unit 101 of the transmission terminal 100 divides i-th data into t packets and transmits the packets to the reception terminal 200 will be described. The loss rate information transmission unit 202 of the reception terminal 200 returns ACK to the loss rate computation unit 104 by the number of packets received by the reception unit 201.

When the number of ACK received by the loss rate computation unit 104 is r, the loss rate computation unit 104 computes a packet loss rate l_i at a time of transmitting i-th data as follows.

l_i=1−r/t expression (1)

The packet loss rate l_i computed by the loss rate computation unit 104 with expression (1) or the like is the actually measured packet loss rate.

[Description of Operations]

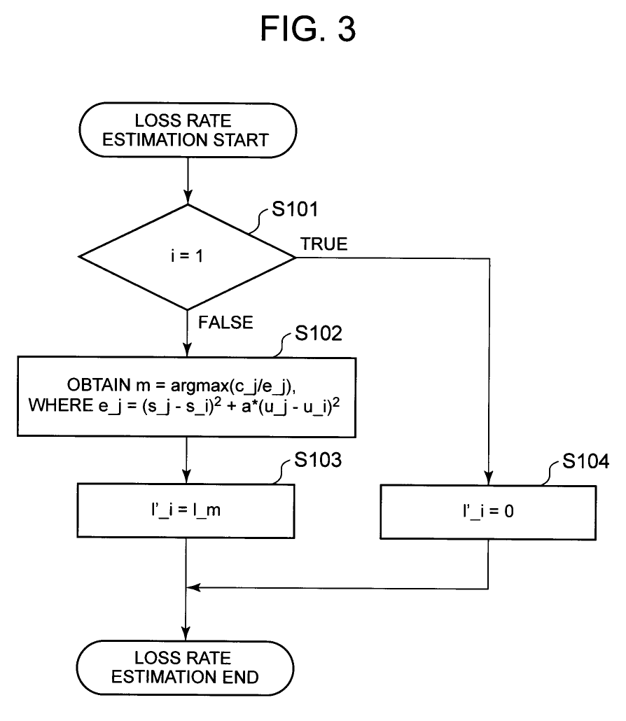

Hereinafter, operations for determining a redundancy of transmission data of the transmission terminal 100 of the present exemplary embodiment will be described with reference to FIG. 3 to FIG. 5.

First, estimation process of a packet loss rate performed by the loss rate estimation unit 106 of the transmission terminal 100 will be described with reference to FIG. 3. FIG. 3 is a flowchart showing operations of estimation process of a packet loss rate performed by the loss rate estimation unit 106.

The loss rate estimation unit 106 checks whether data to be transmitted in data transmission as a target of estimating a packet loss rate is data to be transmitted first or not. That is, the loss rate estimation unit 106 checks whether i=1 is true or not (step S101).

When i=1 is true (True in step S101), the loss rate estimation unit 106 sets an estimated packet loss rate l′_i to 0 (step S104). After the packet loss rate is estimated, the loss rate estimation unit 106 finishes the estimation process of the packet loss rate.

When i=1 is false (False in step S101), for each data set retained in the database unit 103, the loss rate estimation unit 106 obtains a separation e_j between data indicating performance of current transmission processing and data included in the data set. The separation e_j is computed with the following expression.

e_j=(s_j−s_i)²+a*(u_j−u_i)² (0<j<i) expression (2)

Note that the coefficient a in expression (2) is a constant for matching the transmission data rate and the UDP throughput. Further, j corresponds to a data number of a data set retained in the database unit 103.

Also, e_j represents a separation between a data set j retained in the database unit 103 and a data set i relevant to i-th data to be transmitted next. The separation of the present exemplary embodiment means an error of the transmission data rate and the UDP throughput at a time of transmission.

When e_j is large, it is conceivable that the state at a time of transmitting j-th data is different from the state at a time of transmitting i-th data. That is, it is presumed that a packet loss characteristic at the time of transmitting i-th data is different from a packet loss characteristic at the time of transmitting j-th data. Thus, the packet loss rate included in the data set j will not be an estimated value of a packet loss rate at the time of transmitting i-th data.

When e_j is small, it is conceivable that the state at the time of transmitting j-th data is similar to the state at the time of transmitting i-th data. That is, it is presumed that the packet loss characteristic at the time of transmitting i-th data is similar to the packet loss characteristic at the time of transmitting j-th data.

Similarly, when an estimated packet loss rate l′(i+1) at a time of transmitting (i+1)-th data is computed, the loss rate estimation unit 106 computes the separation e_j with the following formula.

e_j=(s_j−s_(i+1))²+a*(u_j−u_(i+1))² (0<j<(i+1))

After the separation e_j is computed for each data set, the loss rate estimation unit 106 obtains a data set m that satisfies the following expression (step S102).

m=argmax(c_j/e_j) (m<=j) expression (3)

That is, the loss rate estimation unit 106 obtains a data set j having a largest (c_j/e_j) by using each e_j computed. The loss rate estimation unit 106 defines obtained data set j as the data set m. The data set m is a data set including data that are closest to s_i and u_i at a time of transmitting i-th data for which transmission is attempted and have highest reliability.

A reason that the data set m is determined with expression (3) will be described below. A packet loss occurs due to a bit error or a queue overflow in a repeater, for example, a wireless LAN (Local Area Network) router, an LTE (Long Term Evolution) base station, or the like. Particularly in an environment where there is no disturbance, when a transmission data rate is higher than a bandwidth such as a UDP throughput, the cause for a packet loss is mostly a queue overflow.

That is, in the environment where there is no disturbance, when a bandwidth and a transmission data rate which are measured accurately are the same as values measured in the past, it is conceivable that the packet loss rate is the same as a value computed in the past.

However, it is conceivable that such an environment where there is no disturbance does not exist. Further, as described above, it is difficult to accurately measure a bandwidth such as the UDP throughput as described above. Thus, the present exemplary embodiment employs a method to use the packet loss rate included in a data set, for which not only the separation is small but also the reliability is high, as an estimation value.

Next, the loss rate estimation unit 106 estimates a packet loss rate l′_i at the time of transmitting i-th data as follows (step S103).

l′_i=l_m expression (4)

Specifically, the packet loss rate l′_i is estimated as an actually measured packet loss rate l_m included in the data set m. However, when the data set m does not exist, or when no data set is registered in the database unit 103, the loss rate estimation unit 106 sets the estimated packet loss rate l′_i to 0.

Similarly, the loss rate estimation unit 106 estimates a packet loss rate l′_(i+1) at a time of transmitting (i+1)-th data as follows.

l′_(i+1)=l_m

The data set m is a data set including data that are closest to s_(i+1) and u_(i+1) at a time of transmitting (i+1)-th data for which transmission is attempted and have highest reliability. After the packet loss rate is estimated, the loss rate estimation unit 106 finishes the estimation process of the packet loss rate.

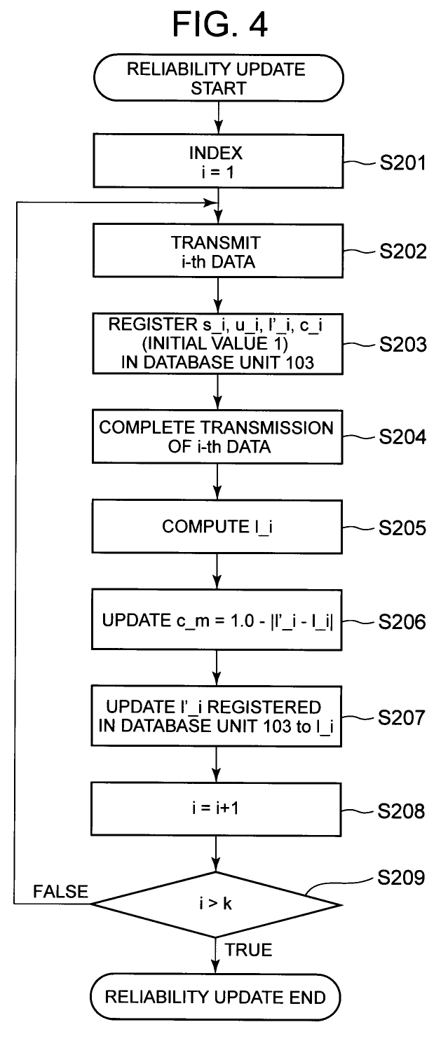

Next, reliability update process performed by the reliability update unit 105 of the transmission terminal 100 will be described with reference to FIG. 4. FIG. 4 is a flowchart showing operations of reliability update process performed by the reliability update unit 105.

In this example, a case where the transmission terminal 100 transmits k number of data will be considered. The reliability update unit 105 starts the reliability update process after first data is transmitted. After the first data is transmitted, the reliability update unit 105 sets index i to 1 (step S201).

The transmission unit 101 transmits i-th data (step S202). Just after i-th data is transmitted, a data set related to transmission of i-th data is registered in the database unit 103 (step S203). The data set registered in step S203 is, for example, data set i showed in FIG. 2.

Next, the reception unit 201 receives i-th data, and thus transmission of i-th data is completed (step S204). After reception of i-th data is completed, the loss rate information transmission unit 202 transmits information needed for computing the packet loss rate in transmission of i-th data.

Next, the loss rate computation unit 104 receives the information needed for computing the packet loss rate transmitted by the loss rate information transmission unit 202. Upon reception of the information, the loss rate computation unit 104 computes the actually measured packet loss rate l_i at a time of transmitting i-th data (step S205). The reliability update unit 105 receives the computed actually measured packet loss rate l_i from the loss rate computation unit 104.

Next, the reliability update unit 105 compares the estimated packet loss rate l′_i included in the data set i related to transmission of i-th data registered in the database unit 103 and the received actually measured packet loss rate l_i.

As a result of comparison, the reliability update unit 105 updates a reliability c_m included in the data set m used in estimation processing of the estimated packet loss rate l′_i as follows (step S206).

c_m=1.0−∥l′_i−l_i| expression (5)

Note that the reason for obtaining an absolute value of difference between l′_i and l_i in expression (5) is to prevent the reliability c_m from becoming larger than 1.0. However, as a result of computation, if the value of the reliability c_m becomes negative, the reliability update unit 105 updates the reliability c_m to 0.

Next, the reliability update unit 105 updates the estimated packet loss rate l′_i included in the data set i registered in the database unit 103 to the actually measured packet loss rate l_i (step S207).

Next, the reliability update unit 105 attaches 1 to the index i (step S208). After the attachment, the reliability update unit 105 checks whether the index i is larger than k or not (step S209).

When the index i is less than or equal to k (False in step S209), the transmission unit 101 performs the processing of S202 again. That is, the reliability update unit 105 proceeds to the update processing of reliability with respect to the estimated packet loss rate l′_(i+1).

When the index i is larger than k (True in step S209), the reliability is updated with respect to the estimated packet loss rate when k number of data, that is, all data are transmitted. The reliability update unit 105 finishes the reliability update process.

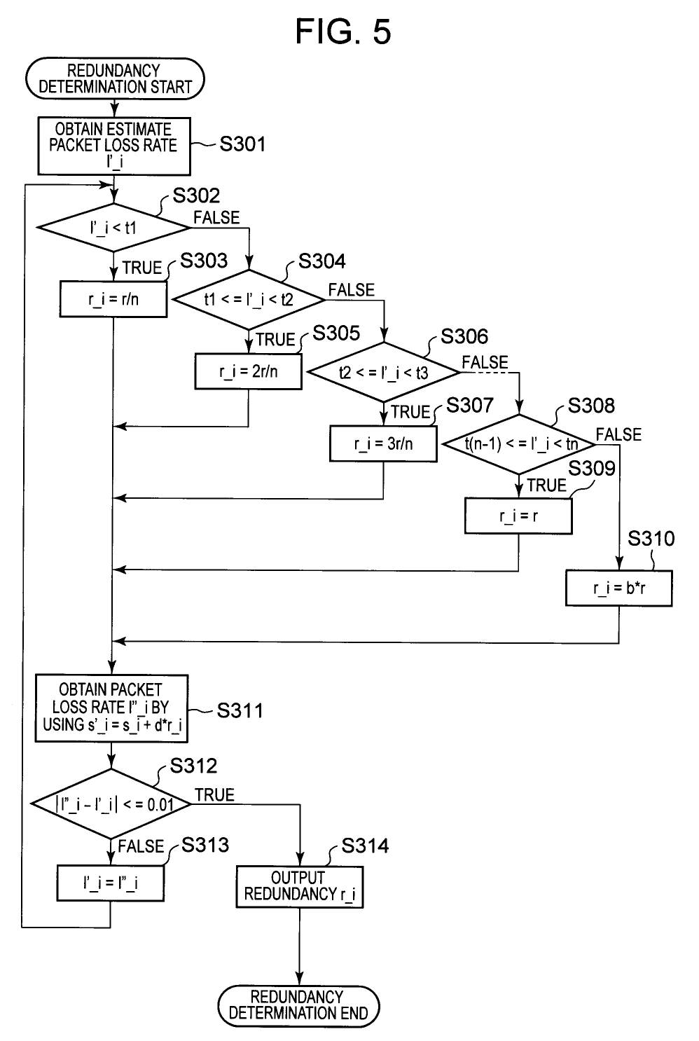

Next, redundancy determination process performed by the redundancy determination unit 107 of the transmission terminal 100 will be described with reference to FIG. 5. FIG. 5 is a flowchart showing operations of redundancy determination process performed by the redundancy determination unit 107.

In this example, a first threshold t1, a second threshold t2, . . . , a n-th threshold tn, a reference redundancy r, and a constant coefficient b are given to the redundancy determination unit 107 by a user in advance. That is, n corresponds to the number of given thresholds. Note that each of the thresholds satisfies the following relational expression.

t1<t2< . . . <tn expression (6)

Just after i-th data is transmitted, the redundancy determination unit 107 obtains the estimated packet loss rate l′_i from the loss rate estimation unit 106 (step S301). Next, the redundancy determination unit 107 checks whether the estimated packet loss rate l′_i obtained in step S301 is smaller than t1 or not (step S302).

When the estimated packet loss rate l′_i is smaller than t1 (True in step S302), the redundancy determination unit 107 determines a redundancy r_i as follows (step S303). After the redundancy r_i is determined, the transmission terminal 100 performs processing of step S311.

r_i=r/n expression (7)

When the estimated packet loss rate l′_i is more than or equal to t1 (False in step S302), the redundancy determination unit 107 determines whether the estimated packet loss rate l′_i is smaller than t2 or not (step S304). When the estimated packet loss rate l′_i is smaller than t2 (True in step S304), the redundancy determination unit 107 determines the redundancy r_i as follows (step S305). After the redundancy r_i is determined, the transmission terminal 100 performs processing of step S311.

r_i=2r/n expression (8)

When the estimated packet loss rate l′_i is more than or equal to t2 (False in step S304), the redundancy determination unit 107 checks whether the estimated packet loss rate l′_i is smaller than t3 or not (step S306). When the estimated packet loss rate l′_i is smaller than t3 (True in step S306), the redundancy determination unit 107 determines the redundancy r_i as follows (step S307). After the redundancy r_i is determined, the transmission terminal 100 performs processing of step S311.

r_i=3r/n expression (9)

Thereafter, the redundancy determination unit 107 performs pieces of processing similar to the pieces of processing of step S302 to step S303 on each of the thresholds. When the estimated packet loss rate l′_i is more than or equal to t(n−1), the redundancy determination unit 107 determines whether the estimated packet loss rate l′_i is smaller than tn or not (step S308). When the estimated packet loss rate l′_i is smaller than tn (True in step S308), the redundancy determination unit 107 determines the redundancy r_i as follows (step S309). After the redundancy r_i is determined, the transmission terminal 100 performs processing of step S311.

r_i=r expression (10)

When the estimated packet loss rate l′_i is more than or equal to tn (False in step S308), the redundancy determination unit 107 determines the redundancy r_i as follows (step S310). After the redundancy r_i is determined, the transmission terminal 100 performs processing of step S311.

r_i=b*r expression (11)

Note that the coefficient b in expression (11) is a constant. When the redundancy determination unit 107 determines the redundancy r_i, the redundancy code unit 108 performs redundancy coding on i-th data. When the redundancy coding is performed, the transmission data rate s_i of transmission processing by the transmission unit 101 increases. In this example, the transmission data rate s_i increases as follows.

s′_i=s_i+d*r_i expression (12)

Note that the coefficient d in expression (12) is a constant for matching scales. A reason why the coefficient d is used in expression (12) is that the unit of transmission data rate and the unit of redundancy are different.

When the transmission data rate increases, the loss rate estimation unit 106 is requested to estimate the packet loss rate again by using s′_i. The loss rate estimation unit 106 estimates a packet loss rate l″_i by using the increased transmission data rate s′_i (step S311). Note that the estimation process of a packet loss rate performed by the loss rate estimation unit 106 is similar to the process showed in FIG. 3.

Next, the redundancy determination unit 107 checks a degree of difference between the packet loss rate l″_i estimated in step S311 and the packet loss rate l′_i obtained in step S301 (step S312). Specifically, the redundancy determination unit 107 checks whether l″_i and l′_i satisfy the following relational expression or not.

|l″_i−l′_i|<=α expression (13)

When expression (13) is satisfied, the difference between l″_i and l′_i is less than or equal to α. When expression (13) is satisfied (True in step S312), the redundancy determination unit 107 sets the redundancy to r_i and outputs the redundancy (step S314). After the redundancy is output, the redundancy determination unit 107 finishes the redundancy determination process. Note that a is a value input by a user in advance, and is 0.01 (1%) as one example.

When expression (13) is not satisfied (False in step S312), the redundancy determination unit 107 takes l″_i estimated in step S311 as the estimated packet loss rate l′_i (step S313). Next, the redundancy determination unit 107 performs the processing of step S302 again.

Note that in the algorithm of redundancy determination process performed by the redundancy determination unit 107 showed in FIG. 5, the redundancy r_i for which the estimated packet loss rate l′_i is a variable has a nature of rectangular function. That is, it is ensured that the redundancy determination process of the present exemplary embodiment does not fall in an infinite loop. This is because a solution is always derived because a definition range in which the value does not change exists in the redundancy r_i even when the estimated packet loss rate l′_i varies.

As described above, the transmission terminal 100 of the present exemplary embodiment can estimate the packet loss rate with high precision by using only information obtained from an application layer, and address a packet loss without impairing immediacy. This is because the reliability update unit 105 compares the estimated packet loss rate and the measured packet loss rate, and updates reliability of the estimated value, thereby improving precision of estimating the packet loss rate. The redundancy determination unit 107 can change the redundancy according to the packet loss rate estimated with high precision.

### Specific Example 1

Next, operations of the transmission terminal 100 and operations of the reception terminal 200 will be described using specific numeric values. In this example, 0.1% is given as a threshold t1, 1.0% is given as a threshold t2, and 4 Kbytes is given as a reference redundancy r by a user. Further, a transmission interval of each data is 100 msec. Further, the constant coefficient b is 2.

First, the transmission terminal 100 transmits first data. A data size of the first data is 18 Kbytes. The transmission data rate s_1 is 0.144 Mbps because it is computed with the initial value. Further, a measurement result of UDP throughput u_1 of the UDP throughput measurement unit 102 when the first data is transmitted is 2.1 Mbps.

The loss rate estimation unit 106 starts the estimation processing of packet loss rate showed in FIG. 3. Nothing is registered in the database unit 103 before the first data is transmitted. That is, because i=1 (True in step S101), the loss rate estimation unit 106 sets the estimated packet loss rate l′_1 to 0.0%. Further, an initial value of reliability is always 1.0 as described above.

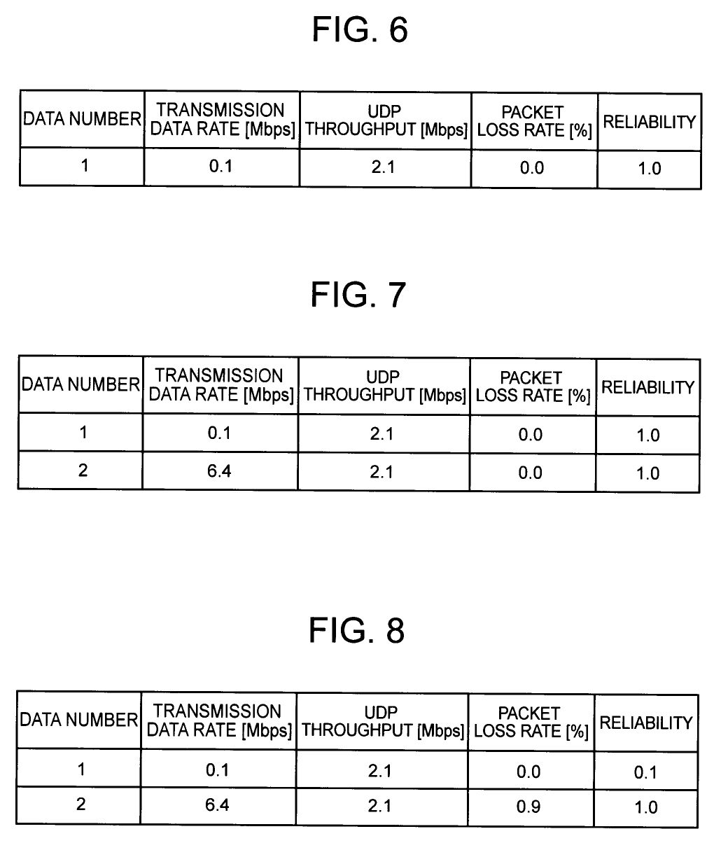

When the transmission unit 101 transmits the first data (step S202), a data set 1 is registered in the database unit 103 (step S203). FIG. 6 is an explanatory diagram showing another example of a data set retained in the database unit 103. FIG. 6 shows a data set registered in the database unit 103 just after the first data is transmitted.

After transmission of the first data is completed (step S204), the loss rate computation unit 104 receives ACK from the loss rate information transmission unit 202. Next, the loss rate computation unit 104 computes an actually measured packet loss rate l_1 (step S205). The actually measured packet loss rate l_1 computed in this example is 0.0%.

Next, the reliability update unit 105 receives the computed actually measured packet loss rate l_1 (=0.0[%]) from the loss rate computation unit 104. The reliability update unit 105 compares the estimated packet loss rate l′_1 (=0.0[%]) included in the data set 1 registered in the database unit 103 and the actually measured packet loss rate l_1.

Next, the reliability update unit 105 updates a reliability c_1 included in the data set 1 (step S206). Because the difference between the estimated packet loss rate l′_1 and the actually measured packet loss rate l_1 is 0 with respect to transmission of the first data, the reliability c_1 is not updated. That is, the reliability c_1 remains as 1.0.

Next, the transmission terminal 100 transmits second data. A data size of the second data is 60 Kbytes. The transmission data rate s_2 is computed as 6.2 Mbps.

The loss rate estimation unit 106 starts the estimation process of a packet loss rate showed in FIG. 3. The loss rate estimation unit 106 retrieves, from data sets registered in the database unit 103, a data set including data that are closest to the transmission data rate s_2 (=6.2 [Mbps]) and the UDP throughput u_2 (=2.1 [Mbps]) and have the highest reliability (step S102).

With reference to FIG. 6, among data sets registered in the database unit 103, a data set that satisfies the above-described conditions is the data set 1. Thus, the loss rate estimation unit 106 computes an estimated packet loss rate l′_2 as follows (step S103).

l′_2=l_1=0.0[%]

Next, the redundancy determination unit 107 receives the estimated packet loss rate l′_2 from the loss rate estimation unit 106 (step S301). The redundancy determination unit 107 checks whether the estimated packet loss rate l′_2 is smaller than t1 or not (step S302). Because l′_2 is smaller than t1 (True in step S302), the redundancy determination unit 107 determines a redundancy r_2 of the second data as follows (step S303).

r_2=r/2=2 [Kbytes]

When the redundancy r_2 is determined as 2 Kbytes, the transmission data rate s_2 increases as follows.

s′_2=s_2+r_2=6.4 [Mbps]

Next, the loss rate estimation unit 106 estimates a packet loss rate l″_2 by using the increased transmission data rate s′_2 (step S311). In this example, the estimated packet loss rate l″_2 does not change from l′_2 (True in step S312). Thus, the redundancy determination unit 107 outputs r_2 (=2 [Kbytes]) as a redundancy (step S314).

Next, the redundancy code unit 108 receives the redundancy r_2 from the redundancy determination unit 107. The redundancy code unit 108 performs redundancy coding of the second data by using the redundancy r_2. Next, the transmission unit 101 transmits the redundancy-coded second data (step S202).

When the transmission unit 101 transmits the second data, a data set 2 is registered in the database unit 103 (step S203). FIG. 7 is an explanatory diagram showing another example of data sets retained in the database unit 103. FIG. 7 shows data sets registered in the database unit 103 just after the second data is transmitted.

After transmission of the second data is completed (step S204), the loss rate computation unit 104 receives ACK from the loss rate information transmission unit 202. Next, the loss rate computation unit 104 computes an actually measured packet loss rate l_2 (step S205). The actually measured packet loss rate l_2 computed in this example is 0.9%.

Next, the reliability update unit 105 receives the actually measured packet loss rate l_2 (=0.9[%]) computed from the loss rate computation unit 104. The reliability update unit 105 compares the estimated packet loss rate l′_2 (=0.0[%]) included in the data set 2 registered in the database unit 103 and the actually measured packet loss rate l_2.

As a result of comparison, the reliability update unit 105 updates the reliability c_1 included in the data set 1 as follows (step S206).

c_1=1.0−|0.0−0.9|=0.1

Further, the reliability update unit 105 updates the estimated packet loss rate l′_2 included in the data set 2 to the actually measured packet loss rate l_2 (step S207). FIG. 8 is an explanatory diagram showing another example of data sets retained in the database unit 103. FIG. 8 shows data sets registered in the database unit 103 after transmission of the second data is completed and each data is updated.

Next, the transmission terminal 100 transmits third data. A data size of the third data is 13 Kbytes. The transmission data rate s_3 is computed as 3.6 Mbps.

The loss rate estimation unit 106 starts the estimation process of a packet loss rate showed in FIG. 3. The loss rate estimation unit 106 retrieves, from data sets registered in the database unit 103, a data set including data that are closest to the transmission data rate s_3 (=3.6 [Mbps]) and the UDP throughput u_3 (=2.1 [Mbps]) and have the highest reliability (step S102).

With reference to FIG. 8, among data sets registered in the database unit 103, a data set that satisfies the above-described conditions is the data set 2. Thus, the loss rate estimation unit 106 computes an estimated packet loss rate l′_3 as follows (step S103).

l′_3=l_2=0.9[%]

Next, the redundancy determination unit 107 receives the estimated packet loss rate l′_3 from the loss rate estimation unit 106 (step S301). The redundancy determination unit 107 checks whether the estimated packet loss rate l′_3 is smaller than t1 or not (step S302). Because l′_3 is larger than t1 (False in step S302), the redundancy determination unit 107 checks whether l′_3 is smaller than t2 or not (step S308).

Because l′_3 is smaller than t2 (True in step S308), the redundancy determination unit 107 determines a redundancy r_3 of the third data as follows (step S309).

r_3=r=4 [Kbytes]

When the redundancy r_3 is determined as 4 Kbytes, the transmission data rate s_3 increases as follows.

s′_3=s_3+r_3=3.8 [Mbps]

Next, the loss rate estimation unit 106 estimates a packet loss rate l″_3 by using the increased transmission data rate s′_3 (step S311). In this example, the estimated packet loss rate l″_3 does not change from 1′_3 (True in step S312). Thus, the redundancy determination unit 107 outputs r_3 (=4 [Kbytes]) as a redundancy (step S314).

Next, the redundancy code unit 108 receives the redundancy r_3 from the redundancy determination unit 107. The redundancy code unit 108 performs redundancy coding of the third data by using the redundancy r_3. Next, the transmission unit 101 transmits the redundancy-coded third data (step S202).

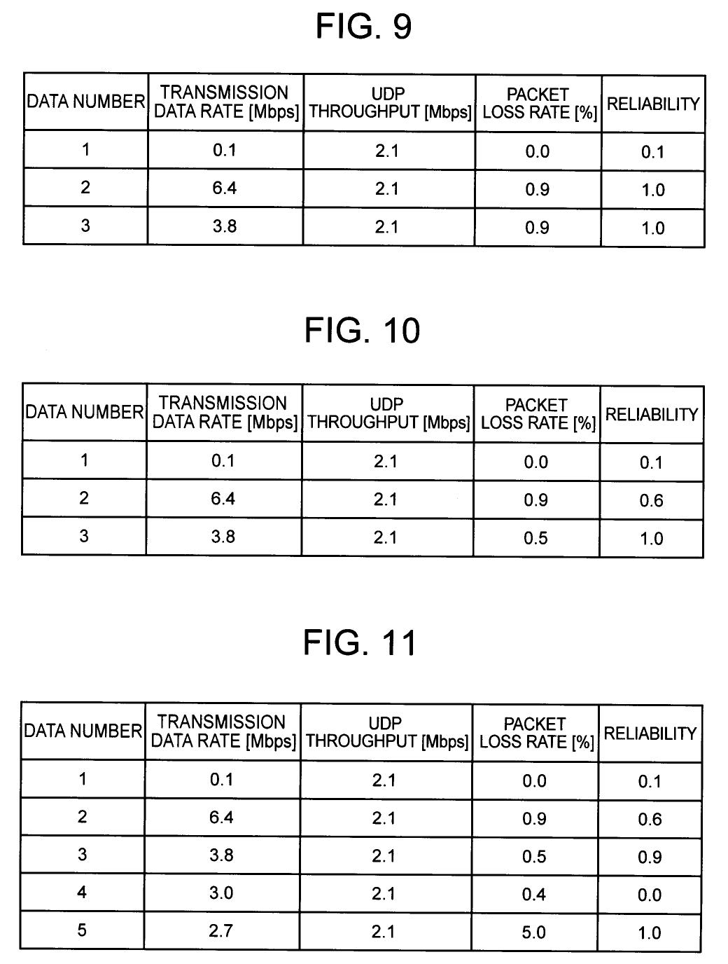

When the transmission unit 101 transmits the third data, a data set 3 is registered in the database unit 103 (step S203). FIG. 9 is an explanatory diagram showing another example of data sets retained in the database unit 103. FIG. 9 shows data sets registered in the database unit 103 just after the third data is transmitted.

After transmission of the third data is completed (step S204), the loss rate computation unit 104 receives ACK from the loss rate information transmission unit 202. Next, the loss rate computation unit 104 computes an actually measured packet loss rate l_3 (step S205). The actually measured packet loss rate l_3 computed in this example is 0.5%.

Next, the reliability update unit 105 receives the computed actually measured packet loss rate l_3 (=0.5[%]) from the loss rate computation unit 104. The reliability update unit 105 compares the estimated packet loss rate l′_3 (=0.9[%]) included in the data set 3 registered in the database unit 103 and the actually measured packet loss rate l_3.

As a result of comparison, the reliability update unit 105 updates a reliability c_2 included in the data set 2 as follows (step S206).

c_2=1.0−|0.9−0.5|=0.6

Further, the reliability update unit 105 updates the estimated packet loss rate l′_3 included in the data set 3 to the actually measured packet loss rate l_3 (step S207). FIG. 10 is an explanatory diagram showing another example of data sets retained in the database unit 103. FIG. 10 shows data sets registered in the database unit 103 after transmission of the third data is completed and each data is updated.

Next, the transmission terminal 100 transmits fourth data with a data size of 14 Kbytes. After transmission of the fourth data is completed (step S204), the loss rate computation unit 104 computes the actually measured packet loss rate l_4 as 0.4% (step S205).

Next, the transmission terminal 100 transmits fifth data with a data size of 16 Kbytes. After transmission of the fifth data is completed (step S204), the loss rate computation unit 104 computes the actually measured packet loss rate l_5 as 5.0% (step S205).

FIG. 11 is an explanatory diagram showing another example of data sets retained in the database unit 103. FIG. 11 shows data sets registered in the database unit 103 after transmission of the fifth data is completed and each data is updated.

Hereinafter, a situation is assumed such that the data sets showed in FIG. 11 are registered in the database unit 103, and a burst loss occurs contingently when the fifth data is transmitted.

Next, the transmission terminal 100 transmits sixth data. A data size of the sixth data is 19 Kbytes. The transmission data rate s_6 is computed as 2.3 Mbps.

The loss rate estimation unit 106 starts the estimation process of a packet loss rate showed in FIG. 3. The loss rate estimation unit 106 retrieves, from data sets registered in the database unit 103, a data set including data that are closest to the transmission data rate s_6 (=2.3 [Mbps]) and the UDP throughput u_6 (=2.1 [Mbps]) and have the highest reliability (step S102).

With reference to FIG. 11, among data sets registered in the database unit 103, a data set that satisfies the above-described conditions is the data set 5. Thus, the loss rate estimation unit 106 computes an estimated packet loss rate l′_6 as follows (step S103).

l′_6=l_5=5.0[%]

Next, the redundancy determination unit 107 receives the estimated packet loss rate l′_6 from the loss rate estimation unit 106 (step S301). Because the estimated packet loss rate l′_6 is larger than t2 (False in step S308), the redundancy determination unit 107 determines a redundancy r_6 of the sixth data as follows (step S310).

r_6=2*r=8 [Kbytes]

When the redundancy r_6 is determined as 8 Kbytes, the transmission data rate s_6 increases as follows.

s′_6=s_6+r_6=2.5 [Mbps]

Next, the loss rate estimation unit 106 estimates a packet loss rater 6 by using the increased transmission data rate s′_6 (step S311). In this example, the estimated packet loss rate l″_6 does not change from l′_6 (True in step S312). Thus, the redundancy determination unit 107 outputs r_6 (=8 [Kbytes]) as a redundancy (step S314).

Next, the redundancy code unit 108 receives the redundancy r_6 from the redundancy determination unit 107. The redundancy code unit 108 performs redundancy coding of the sixth data by using the redundancy r_6. Next, the transmission unit 101 transmits the redundancy-coded sixth data (step S202).

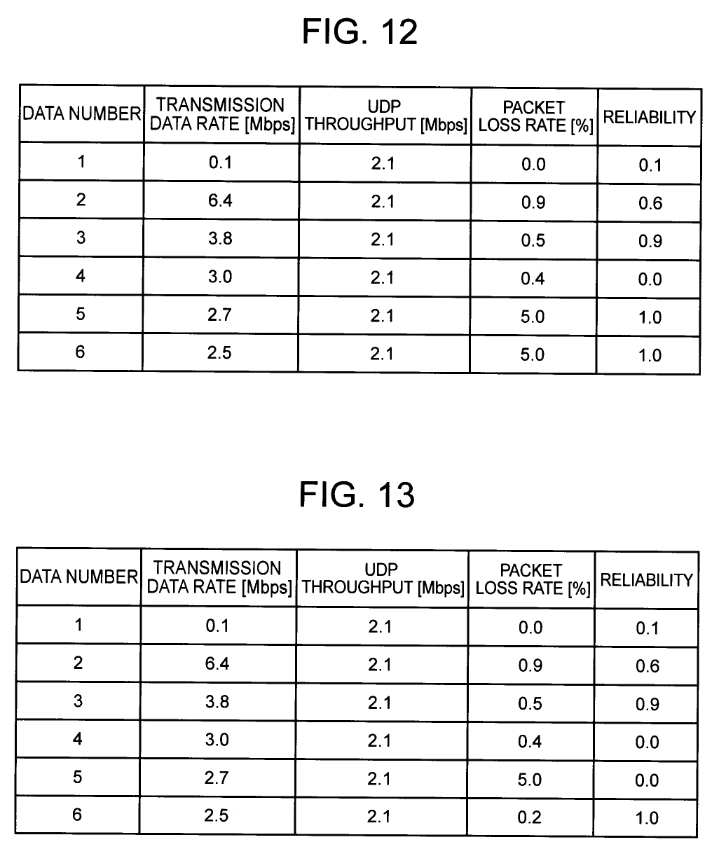

When the transmission unit 101 transmits the sixth data, a data set 6 is registered in the database unit 103 (step S203). FIG. 12 is an explanatory diagram showing another example of data sets retained in the database unit 103. FIG. 12 shows data sets registered in the database unit 103 just after the sixth data is transmitted.

After transmission of the sixth data is completed (step S204), the loss rate computation unit 104 receives ACK from the loss rate information transmission unit 202. Next, the loss rate computation unit 104 computes an actually measured packet loss rate l_6 (step S205). The actually measured packet loss rate l_6 computed in this example is 0.2%.

Next, the reliability update unit 105 compares the actually measured packet loss rate l_6 (=0.2[%]) and the estimated packet loss rate l′_6 (=5.0[%]). As a result of comparison, the reliability update unit 105 computes a reliability c_5 included in the data set 5 as follows (step S206).

c_5=1.0−|5.0−0.2|=−3.8

As described above, the reliability c_5 becomes less than 0. Thus, the reliability update unit 105 updates the reliability c_5 to 0.0. Further, the reliability update unit 105 updates the estimated packet loss rate l′_6 included in the data set 6 to the actually measured packet loss rate l_6 (step S207).

FIG. 13 is an explanatory diagram showing another example of data sets retained in the database unit 103. FIG. 13 shows data sets registered in the database unit 103 after transmission of the sixth data is completed and each data is updated.

Next, the transmission terminal 100 transmits seventh data. A data size of the seventh data is 50 Kbytes. The transmission data rate s_7 is computed as 2.8 Mbps.

The loss rate estimation unit 106 starts the estimation process of a packet loss rate showed in FIG. 3. The loss rate estimation unit 106 retrieves, from data sets registered in the database unit 103, a data set including data that are closest to the transmission data rate s_7 (=2.8 [Mbps]) and the UDP throughput u_7 (=2.1 [Mbps]) and have the highest reliability (step S102).

With reference to FIG. 13, among data sets registered in the database unit 103, a data set including data that are closest to the transmission data rate s_7 and the UDP throughput u_7 is the data set 5. However, because the reliability is also considered, the loss rate estimation unit 106 chooses the data set 6. Thus, the loss rate estimation unit 106 computes an estimated packet loss rate l′_7 as follows (step S103).

l′_7=l_6=0.2[%]

As described above, the loss rate estimation unit 106 estimates the packet loss rate on the basis not only of the transmission data rate and the UDP throughput but also of the reliability, thereby minimizing influence of the burst loss which occurred contingently when the fifth data is transmitted. That is, the reliability update unit 105 can improve precision of estimating the packet loss rate.

[Description of Effects]

It is an object of the communication system 10 according to the present exemplary embodiment to maximize use efficiency of transmittable band while addressing a packet loss. In order to achieve the above-described object, the communication system 10 estimates a state of the communication network between the transmission terminal 100 and the reception terminal 200 by using only information obtained from an application layer, and changes a redundancy according to the estimated state. The communication system 10 determines the redundancy in particular by estimating a packet loss rate.

The transmission terminal 100 according to the present exemplary embodiment includes a transmission unit 101 transmitting data, a UDP throughput measurement unit 102 measuring a UDP throughput of the transmission unit 101, and a loss rate computation unit 104 computing a packet loss rate. Further, the transmission terminal 100 includes a reliability update unit 105 updating reliability of an estimated value of the packet loss rate on the basis of information output from the loss rate computation unit 104.

The transmission terminal 100 according to the present exemplary embodiment has a database unit 103 retaining as a data set each piece of information output from the UDP throughput measurement unit 102, the loss rate computation unit 104, and the reliability update unit 105. Further, the transmission terminal 100 includes a loss rate estimation unit 106 estimating a packet loss rate on the basis of past time-series data retained by the database unit 103 and a redundancy determination unit 107 determining a redundancy on the basis of the packet loss rate output by the loss rate estimation unit 106.

Further, the transmission terminal 100 of the present exemplary embodiment includes a redundancy code unit 108 performing redundancy coding by using the redundancy determined by the redundancy determination unit 107. By the redundancy determination unit 107 changing the redundancy according to the packet loss rate estimated by the loss rate estimation unit 106, the transmission terminal 100 can maximize use efficiency of transmittable band while recovering lost data. Further, even when a burst loss or the like occurs contingently, because the reliability update unit 105 updates the reliability, the transmission terminal 100 can minimize influence of the burst loss on estimation precision of the packet loss rate.

When the redundancy is updated corresponding to variations in packet loss rate, if the burst loss is considered, highly precise estimation and prediction of the packet loss rate become difficult. Further, redundancy coding is performed with an inappropriate redundancy, and thus it is conceivable that useless data is transmitted or decoding of data fails.

The transmission terminal 100 of the present exemplary embodiment can maximize use efficiency of transmittable band while recovering lost data by changing the redundancy according to the estimated packet loss rate. Even when a burst loss occurs contingently, by the reliability update unit 105 updating the reliability, the transmission terminal 100 can minimize influence of the burst loss on estimation precision of the packet loss rate.

Note that the transmission terminal 100 and the reception terminal 200 of the present exemplary embodiment are achieved by, for example, a central processing unit (CPU) executing processing according to a program stored in a storage medium. Specifically, the transmission unit 101, the UDP throughput measurement unit 102, the loss rate computation unit 104, the reliability update unit 105, the loss rate estimation unit 106, the redundancy determination unit 107, the redundancy code unit 108, the reception unit 201, and the loss rate information transmission unit 202 are achieved by, for example, the CPU executing processing according to program control.

Further, the database unit 103 is achieved by, for example, a random access memory (RAM).

Further, each of the units in the transmission terminal 100 and the reception terminal 200 of the present exemplary embodiment may be achieved by a hardware circuit. As one example, each of the transmission unit 101, the UDP throughput measurement unit 102, the database unit 103, the loss rate computation unit 104, the reliability update unit 105, the loss rate estimation unit 106, the redundancy determination unit 107, the redundancy code unit 108, the reception unit 201, and the loss rate information transmission unit 202 is achieved by an LSI (Large Scale Integration). Further, these units may be achieved by one LSI.

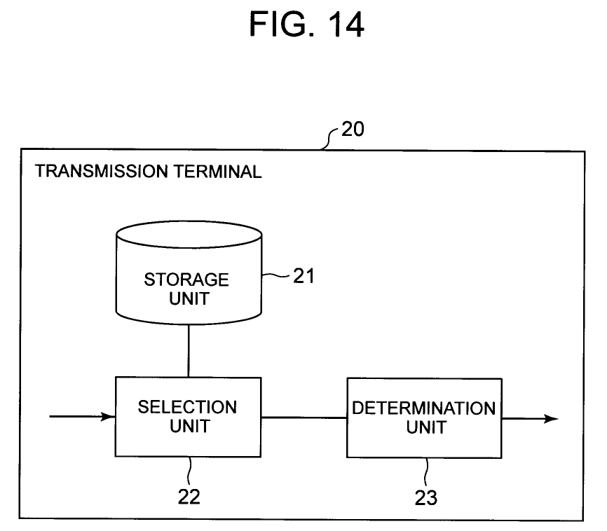

Next, an overview of the present invention will be described. FIG. 14 is a block diagram showing an overview of a transmission terminal according to the present invention. A transmission terminal 20 according to the present invention includes a storage unit 21 (for example, the database unit 103) which stores transmission information including a packet loss rate in transmission processing executed in past, a reliability of the packet loss rate, and performance data indicating performance of the transmission processing on a transmission-processing-by-transmission-processing basis, a selection unit 22 (for example, the loss rate estimation unit 106) which selects, from among the stored pieces of transmission information, transmission information having maximum ratio of the reliability to a difference between data indicating the performance of measured transmission processing and the performance data, and a determination unit 23 (for example, the redundancy determination unit 107) which determines a redundancy to be attached to data to be transmitted in transmission processing the performance of which has been measured using the packet loss rate included in the selected transmission information.

With such a configuration, the transmission terminal can improve use efficiency of a transmittable band while addressing the packet loss with variations of a state of the communication network between a transmission terminal and a reception terminal being considered.

Further, the selection unit 22 may estimate the packet loss rate included in the selected transmission information as a packet loss rate in transmission processing the performance of which has been measured.

With such a configuration, the transmission terminal can estimate a packet loss rate included in a data set that is closest to measured data and has a highest reliability as a packet loss rate in transmission processing.

Further, the transmission terminal 20 may include an attachment unit (for example, the redundancy code unit 108) which attaches a determined redundancy to data to be transmitted.

With such a configuration, the transmission terminal can transmit data to which a redundancy according to an estimated packet loss rate is attached.

Further, the transmission terminal 20 may include a transmission unit (for example, the transmission unit 101) which transmits data to which a redundancy is attached, and a measurement unit (for example, the UDP throughput measurement unit 102) which measures performance of transmission processing by the transmission unit, wherein the measurement unit may attach to the storage unit 21 transmission information including performance data that is data indicating the measured performance of the transmission processing, the estimated packet loss rate, and a reliability that is a predetermined value.

With such a configuration, the transmission terminal can attach a data set related to newly executed transmission processing to the storage unit.

Further, the transmission terminal 20 may include a loss rate computation unit (for example, the loss rate computation unit 104) which computes a packet loss rate in transmission processing by the transmission unit, and a reliability computing unit (for example, the reliability update unit 105) which computes a reliability by using the computed packet loss rate, wherein the loss rate computation unit may update the estimated packet loss rate included in the transmission information related to the transmission processing to the computed packet loss rate, and the reliability computation unit may update the reliability included in the selected transmission information to the computed reliability.

With such a configuration, the transmission terminal can update information included in a data set stored in the storage unit to more accurate information.

Further, the measurement unit may measure a throughput by which the transmission unit transmits data.

With such a configuration, the transmission terminal can estimate a packet loss rate by using a throughput of transmission processing.

In the foregoing, although the present invention has been described with reference to exemplary embodiments and examples, the present invention is not limited to the embodiments and examples. Various changes can be made to the configurations and details of the present invention that can be understood by a person skilled in the art within the scope of the present invention.

This application claims the benefit of priority based on Japanese Patent Application No. 2016-167948 filed on Aug. 30, 2016, the entire disclosure of which is incorporated herein by reference.

### REFERENCE SIGNS LIST

10 communication system
20, 100 transmission terminal
21 storage unit
22 selection unit
23 determination unit
101 transmission unit
102 UDP throughput measurement unit
103 database unit
104 loss rate computation unit
105 reliability update unit
106 loss rate estimation unit
107 redundancy determination unit
108 redundancy code unit
200 reception terminal
201 reception unit
202 loss rate information transmission unit
300 communication network

1. A transmission terminal comprising:
a storage unit which stores transmission information including a packet loss rate in transmission processing executed in past, a reliability of the packet loss rate, and performance data indicating performance of the transmission processing on a transmission-processing-by-transmission-processing basis;
a selection unit which selects, from among the stored pieces of transmission information, transmission information having maximum ratio of the reliability to a difference between data indicating the performance of measured transmission processing and the performance data; and
a determination unit which determines a redundancy to be attached to data to be transmitted in transmission processing the performance of which has been measured using the packet loss rate included in the selected transmission information.

2. The transmission terminal according to claim 1, wherein
the selection unit estimates the packet loss rate included in the selected transmission information as a packet loss rate in transmission processing the performance of which has been measured.

3. The transmission terminal according to claim 1, further comprising
an attachment unit which attaches a determined redundancy to data to be transmitted.

4. The transmission terminal according to claim 2, further comprising:
a transmission unit which transmits data to which a redundancy is attached; and
a measurement unit which measures performance of transmission processing by the transmission unit,
wherein the measurement unit attaches to the storage unit transmission information including performance data that is data indicating the measured performance of the transmission processing, the estimated packet loss rate, and a reliability that is a predetermined value.

5. The transmission terminal according to claim 4, further comprising:
a loss rate computation unit which computes a packet loss rate in transmission processing by the transmission unit;
a reliability computation unit which computes a reliability by using the computed packet loss rate, wherein
the loss rate computation unit updates the estimated packet loss rate included in the transmission information related to the transmission processing to the computed packet loss rate, and
the reliability computation unit updates the reliability included in the selected transmission information to the computed reliability.

6. The transmission terminal according to claim 4, wherein
the measurement unit measures a throughput by which the transmission unit transmits data.

7. A transmission method comprising:
storing transmission information including a packet loss rate in transmission processing executed in past, a reliability of the packet loss rate, and performance data indicating performance of the transmission processing on a transmission-processing-by-transmission-processing basis;
selecting, from among the stored pieces of transmission information, transmission information having maximum ratio of the reliability to a difference between data indicating the performance of measured transmission processing and the performance data; and
determining a redundancy to be attached to data to be transmitted in transmission processing the performance of which has been measured using the packet loss rate included in the selected transmission information.

8. The transmission method according to claim 7, further comprising
estimating the packet loss rate included in the selected transmission information as a packet loss rate in transmission processing the performance of which has been measured.

9. A non-transitory computer-readable recording medium having recorded therein a transmission program causing a computer to execute:
storage processing of storing transmission information including a packet loss rate in transmission processing executed in past, a reliability of the packet loss rate, and performance data indicating performance of the transmission processing on a transmission-processing-by-transmission-processing basis;
selection processing of selecting, from among the stored pieces of transmission information, transmission information having maximum ratio of the reliability to a difference between data indicating the performance of measured transmission processing and the performance data; and
determination processing of determining a redundancy to be attached to data to be transmitted in transmission processing the performance of which has been measured using the packet loss rate included in the selected transmission information.

10. The medium according to claim 9 causing a computer to execute:
estimation processing of estimating the packet loss rate included in the selected transmission information as a packet loss rate in transmission processing the performance of which has been measured.

11. The transmission terminal according to claim 2, further comprising
an attachment unit which attaches a determined redundancy to data to be transmitted.

12. The transmission terminal according to claim 5, wherein
the measurement unit measures a throughput by which the transmission unit transmits data.
